(19) United States
(12) Patent Application Publication
(10) Pub. No.: US 2009/0206983 A1
(43) Pub. Date: Aug. 20, 2009

(54) Communication System for a Radio-Frequency Load Control System

(75) Inventors: Galen Edgar Knode, Macungie, PA (US); Daniel Curtis Raneri, Bethlehem, PA (US); Richard L. Black, Gilbertsville, PA (US); Jordan Henry Crafts, Macungie, PA (US)

Correspondence Address: LUTRON ELECTRONICS CO., INC.;MARK E. ROSE, 7200 SUTER ROAD, COOPERSBURG, PA, 18036-1299, US

(73) Assignee: LUTRON ELECTRONICS CO., INC., Coopersburg, PA (US)

(21) Appl. No.: 12/033,223

(22) Filed: Feb. 19, 2008

(51) Int. Cl. G05B 19/04

(52) U.S. Cl. 340/3.7

(57) ABSTRACT

A radio-frequency (RF) load control system allows for the expedient transmission of subsequent digital messages to one or more recipients via an RF communication link. The control system comprises at least one load control device for controlling the amount of power delivered to an electrical load in response to a received digital message. Each control device of the load control system is operable to interrupt the propagation of a first digital message to transmit a second digital message in response to determining that the second digital message has a high priority than the first digital message. For example, an originating control device may transmit first and second digital messages in response to a press and a release of an actuator, respectively, and may interrupt the propagation of the first digital message to transmit the second digital message if the first digital message is irrelevant in view of the second digital message.

### BACKGROUND OF THE INVENTION

1. Field of the Invention

The present invention relates to load control systems for controlling electrical loads and more particularly to a communication protocol for a wireless load control system, such as, for example, a radio-frequency (RF) lighting control system.

2. Description of the Related Art

Control systems for controlling electrical loads, such as lights, motorized window treatments, and fans, are known. Such control systems often use radio-frequency (RF) transmissions to provide wireless communication between the control devices of the system. Examples of RF lighting control systems are disclosed in commonly-assigned U.S. Pat. No. 5,905,442, issued on May 18, 1999, entitled METHOD AND APPARATUS FOR CONTROLLING AND DETERMINING THE STATUS OF ELECTRICAL DEVICES FROM REMOTE LOCATIONS, and commonly-assigned U.S. Pat. No. 6,803,728, issued Oct. 12, 2004, entitled SYSTEM FOR CONTROL OF DEVICES. The entire disclosures of both patents are hereby incorporated by reference.

The RF lighting control system of the '442 patent includes wall-mounted load control devices (e.g., dimmers) and table-top and wall-mounted master controls (i.e., keypads). The control devices of the RF lighting control system comprise RF antennas adapted to transmit and receive the RF signals that provide for communication between the control devices of the lighting control system. Each of the load control devices includes a user interface and an integral dimmer circuit for controlling the intensity of an attached lighting load. The user interface has a pushbutton actuator for providing on/off control of the attached lighting load and a raise/lower actuator for adjusting the intensity of the attached lighting load.

The table-top and wall-mounted master controls have a plurality of buttons and are operable to transmit digital messages via the RF signals to the load control devices to control the intensities of the lighting loads. The master controls typically comprise preset buttons, which may be programmed to select lighting presets (i.e., scenes) or to toggle the lighting loads in an area on and off. Often, the master controls comprise raise and lower buttons that cause one or more lighting loads to increase and decrease in intensity, respectively, as the raise and lower buttons are held. The master controls transmit digital messages via the RF signals to the controlled load control devices in response to both the press and the release of one of the raise or lower buttons.

The load control devices and master controls of the RF lighting control system of the '442 patent have limited communication ranges. Therefore, the prior art RF lighting control system comprises signal repeaters, such that the load control devices and master controls may be physically located away from each other at distances greater than the respective communication ranges. The signal repeaters repeat (i.e., re-transmit) the digital messages transmitted by the load control devices and master controls multiple times such that every control device of the system is operable to receive all of the transmitted RF signals.

The RF lighting control system of the '442 patent is a time division system, i.e., each of the control devices has a specific time period (or time slot) to transmit digital message to thus avoid collisions. In order to allow for the re-transmissions by the signal repeaters, the communication protocol of the RF lighting control system of the '442 patent includes specific additional time slots in which the signal repeaters are operable to re-transmit the digital messages. As the originating control device transmits a specific digital message and the signal repeaters re-transmit the digital message, the digital message “propagates” through the lighting control system. Since the load control devices and the master controls of the RF lighting control system wait until the propagation of a transmitted digital message is complete before transmitting a new digital message, there can be a substantially long time (i.e., 900 msec) between when the original digital message and the new digital message may be transmitted.

This delay between transmissions can cause a number of problems when the control devices of the RF lighting control system are physically spaced apart in a large area and the system includes a large number of signal repeaters (e.g., five signal repeaters). For example, when a master control having raise and lower buttons is controlling a load control device and is located a long distance away from the load control device, the delay between transmissions may cause overshoot (or undershoot) of the intensity of the lighting load controlled by the load control device in response to taps, i.e., short transitory actuations, of the raise buttons (and lower buttons) of the master control. Because the digital messages are transmitted in response to both the press and the release of one of the raise or lower buttons, there may be a large delay between the “press” digital message and the “release” digital message even if the actual actuation of the raise or lower button was very short in duration. Since the load control device does not stop raising (or lowering) the intensity of the lighting load until the release digital message is received, the load control device may overshoot (or undershoot) the actual desired lighting intensity.

Thus, there is a need for an RF load control system, in which control devices can more quickly communicate subsequent button actuations to an intended recipient or group of recipients.

### SUMMARY OF THE INVENTION

According to the present invention, a method of transmitting a digital message across a communication network having a plurality of control devices comprising the steps of: (1) transmitting a first digital message; (2) propagating the first digital message through the communication network; (3) determining that a second digital message has a higher priority than the first digital message; and (4) interrupting the step of propagating the first digital message to transmit the second digital message. Preferably, the step of determining that a second digital message has a higher priority than the first digital message may comprise determining that the first digital message is irrelevant in view of the second digital message.

The present invention further provides a radio-frequency load control system for controlling the amount of power delivered from an AC power source to a plurality of electrical loads. The load control system comprising a plurality of control devices adapted to be coupled to an RF communication link for communicating digital messages with each other. At least one of the control devices is operable to transmit a first digital message via the RF communication link, such that the first digital message is propagated through the RF load control system. At least one of the control devices is operable to receive the first digital message and to control the amount of power delivered to the electrical load in response to the first digital message. At least one of the control devices is operable to determine that a second digital message has a higher priority than the first digital message, and to interrupt the propagation of the first digital message by transmitting the second digital message.

According to another embodiment of the present invention, a radio-frequency load control system comprises a plurality of control devices adapted to be coupled to an RF communication link for communicating digital messages with each other. The plurality of control devices comprises an originating control device operable to transmit a first digital message via the RF communication link, such that the first digital message is propagated through the RF load control system. The plurality of control devices further comprises a load control device adapted to be coupled between an AC power source and an electrical load, such that the load control device operable to receive the first digital message and to control the amount of power delivered to the electrical load in response to the first digital message. The originating control device is operable to determine that the first digital message is irrelevant in view of a second digital message, and to interrupt the propagation of the first digital message by transmitting the second digital message.

According to another aspect of the present invention, a method of transmitting a digital message across a communication network having a plurality of control devices comprising the steps of: (1) transmitting a first digital message during a first time slot; (2) propagating the first digital message through the communication network; (3) receiving the first digital message; and (4) transmitting an acknowledgement message in response to first digital message during a second time slot before the step of propagating the first digital message is complete.

In addition, the present invention provides a radio-frequency load control system for controlling the amount of power delivered from an AC power source to a plurality of electrical loads. The load control system comprises a plurality of control devices adapted to be coupled to an RF communication link for communicating digital messages with each other. At least one of the control devices operable to transmit a first digital message via the RF communication link during a first time slot, such that the first digital message is propagated through the RF load control system. At least one of the control devices is operable to receive the first digital message, and to transmit an acknowledgement message in response to first digital message during a second time slot before the propagation of the first digital message is complete.

Other features and advantages of the present invention will become apparent from the following description of the invention that refers to the accompanying drawings.

### BRIEF DESCRIPTION OF THE DRAWINGS

FIG. 1 is a simplified block diagram of an RF lighting control system according to the present invention;

FIG. 2 is a simplified timing diagram showing an example of the digital messages transmitted by each of a plurality of control devices of the load control system of FIG. 1 during a command message event;

FIG. 3 is a simplified timing diagram showing an example of an ACK propagation event transmitted after the command message event of FIG. 2;

FIG. 4 is a simplified timing diagram showing an example of a system status event transmitted after the command message event of FIG. 2;

FIG. 5 is a simplified timing diagram showing an example of a superseding command message transmitted during the command message event according to the present invention;

FIG. 6 is a simplified flowchart of a button procedure, which is executed periodically by keypads of the lighting control system of FIG. 1;

FIG. 7 is a simplified flowchart of a command transmitting procedure, which is executed periodically by keypads and wall-mounted dimmers of the load control system of FIG. 1;

FIG. 8 is a simplified flowchart of a message receiving procedure, which is executed by each of the control devices of the load control system of FIG. 1 in response to receiving a command message;

FIGS. 9A and 9B are simplified flowcharts of a slot procedure, which is executed periodically by each of the control devices of the load control system of FIG. 1;

FIG. 9C is a simplified flowchart of a backoff routine called from the slot procedure of FIGS. 9A and 9B;

FIG. 10 is a simplified flowchart of a processing procedure, which is executed periodically by wall-mounted dimmers and remote dimming modules of the lighting control system of FIG. 1;

FIGS. 11A and 11B are simplified flowcharts of a repeater receiving procedure, which is executed by signal repeaters of the lighting control system of FIG. 1;

FIG. 12 is a simplified flowchart of a repeater slot procedure, which is executed by signal repeaters of the load control system of FIG. 1;

FIG. 13 is a simplified flowchart of a receiving procedure executed by a control device of an RF mesh network according to a second embodiment of the present invention;

FIG. 14 is a simplified flowchart of a transmitting procedure executed by the control device of the RF mesh network according to the second embodiment of the present invention; and

FIG. 15 is a simplified flowchart of an ACK list procedure executed periodically by the control device of the RF mesh network according to the second embodiment of the present invention.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

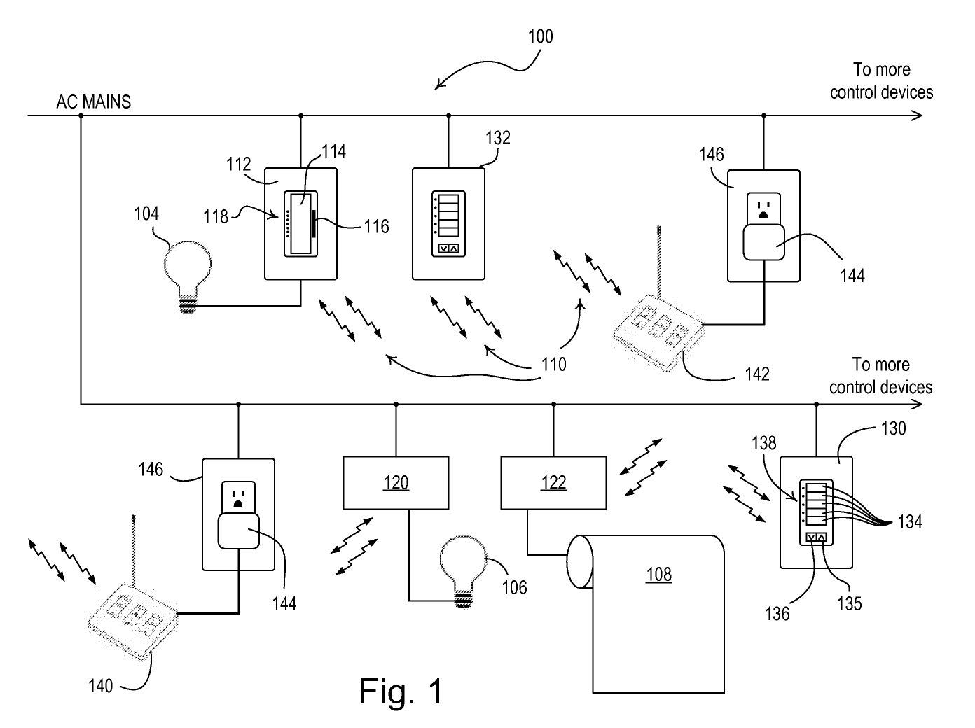

FIG. 1 is a simplified block diagram of an RF load control system 100 according to the present invention. The RF load control system 100 is operable to control the power delivered from a source of AC power (e.g., an AC mains voltage, such as 120 VAC @60 Hz) to a plurality of electrical loads, for example, lighting loads 104, 106 and a motorized roller shade 108. The RF load control system 100 utilizes a wireless RF communication link for communication of digital messages between the control devices of the system via wireless RF signals 110. Each of the control devices is assigned an address (i.e., a unique identifier) during configuration of the load control system 100 to allow each of the control devices to transmit the digital message to a specific control device. According to a first embodiment of the present invention, the control devices of the load control system 100 communicate the digital messages using a time division technique, i.e., each control device transmits digital message during predetermined time slots, as will be described in greater detail below.

The RF load control system 100 comprises a wall-mounted dimmer 112 and a remote dimming module 120, which are each operable to toggle the respective lighting load 104, 106 on and off, and to control the intensity of the respective lighting load 104, 106 between a minimum intensity and a maximum intensity, i.e., a across dimming range of the lighting load. The wall-mounted dimmer 112 includes a user interface for receiving inputs from a user and for providing feedback of the intensity of the controlled lighting load 104 to the user. Specifically, the dimmer 112 comprises a control actuator 114 for turning on and off (i.e., toggling) the lighting load 104 and an intensity adjustment actuator 116 (e.g., a slider control or a rocker switch) for adjusting the intensity of the lighting load. The wall-mounted dimmer 112 also comprises one or more visual indicators 118, e.g., light-emitting diodes (LEDs), for providing feedback to the user of the dimmer. The remote dimming module 120 may comprise, for example, an electronic dimming ballast for controlling a fluorescent lamp, and is typically mounted near the lighting fixture of the fluorescent lamp.

A motorized window treatment (MWT) control module 122 is coupled to the motorized roller shade 108 for controlling the position of the shade fabric of the roller shade and thus the amount of daylight entering the space. Often, the MWT control module 122 is located inside the roller tube of the motorized roller shade 108.

The RF load control system 100 may further comprise a first wall-mounted master keypad 130 and a second wall-mounted master keypad 132. The keypads 130, 132 each comprise a plurality of preset buttons 134, which may be programmed, for example, to recall lighting presets or toggle one or more lighting loads 104, 106 on and off. The keypads 130, 132 may also comprise a raise button 135 and a lower button 136 for respectively raising and lowering the intensities of one or more of the lighting loads 104, 106. The preset buttons 134, the raise button 135, and the lower button 136 may also be programmed to control the position of the motorized roller shade 108. The keypads may also comprise a plurality of visual indicators 138 (e.g., LEDs) for display feedback of, for example, which preset is selected or which lighting loads 104, 106 are energized.

In response to an actuation of one of the buttons 134, 135, 136, the keypads 130, 132 transmit “command” digital messages via the RF signals 110 to the wall-mounted dimmer 112, the remote dimming module 120, and the MWT control module 122 to control the associated loads. The wall-mounted dimmer 112 is also operable to transmit command messages in response to actuations of the control actuator 114 and the intensity adjustment actuator 116. After receiving a command message, the control devices of the load control system 100 are operable to transmit acknowledgement (ACK) messages to the control device that originated the command message. Preferably, the each of the control devices of the load control system 100 is operable to transmit a new command message when the RF communication link is idle, i.e., no control devices are presently transmitting RF signals 110. The originating control device is operable to re-transmit the command message multiple times to ensure that all control devices within the communication range of the originating control device receive the command message.

The load control system 100 also comprises signal repeaters 140, 142 which retransmit any received digital messages to ensure that all of the control devices of the load control system receive all of the RF signals 110. The system may comprise, for example, one to five signal repeaters depending upon the physical size of the load control system 100. Each of the control devices of the load control system 100 are located within the communication range of one of the signal repeaters 140, 142. The signal repeaters 140, 142 are coupled to the AC mains voltage via power supply 144 plugged into electrical outlets 146.

Preferably, one of the signal repeaters 140 operates as a “main” repeater to facilitate the operation of the load control system 100. The main repeater has a database, which defines the operation of the load control system, stored in memory. For example, the main repeater is operable to determine which of the lighting loads 104, 106 is energized and to use the database to control the visual indicators 118, 138 of the dimmer 112 and the keypads 130, 132 accordingly to provide the appropriate feedback to the user of the load control system.

Preferably, each of the control devices stores a portion of the database pertaining to the functionality of the specific control device. For example, each of the keypads 130, 132 may store a portion of the database that determines which lighting presets are selected in response to actuations of the preset buttons 134. Accordingly, if the database directs that a first preset is selected in response to an actuation of the first preset button 134, the keypads 130, 132 are operable to transmit an appropriate “preset” command message (i.e., for the first preset). However, some control devices of the load control system 100 may not have an appropriate amount of memory to store even a portion of the database. Therefore, these control devices alternatively transmit “button” command messages that simply include information regarding which one of the buttons was pressed rather than, for example, a specific preset.

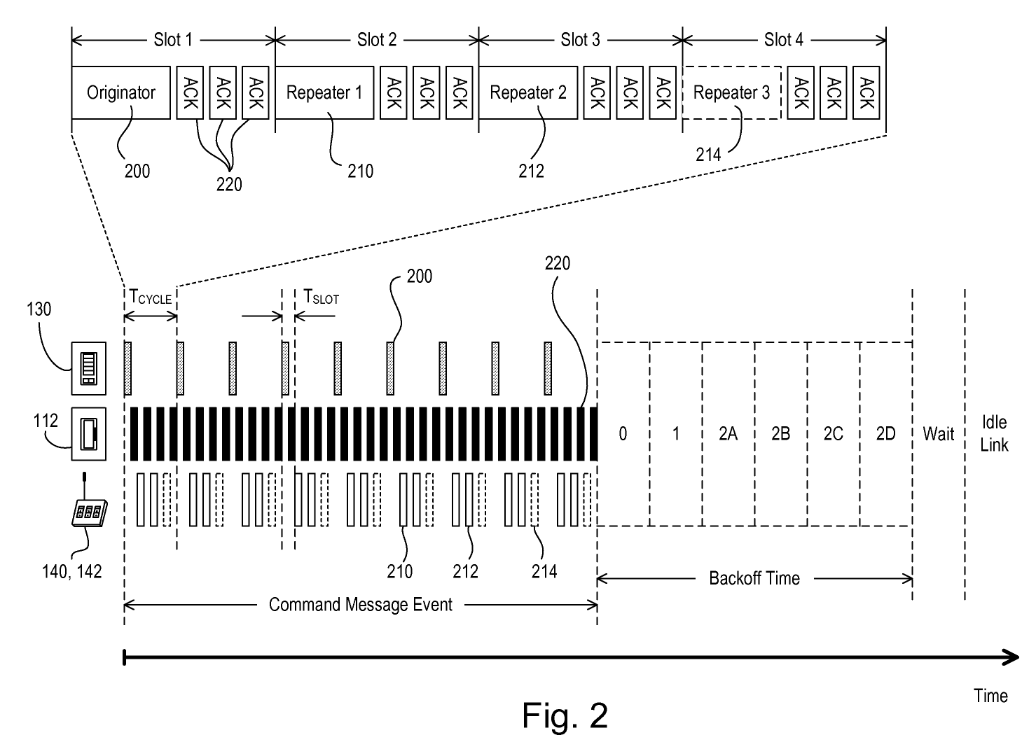

FIG. 2 is a simplified timing diagram showing an example of the timing of the digital messages transmitted by each of the control devices of the load control system 100 during a command message event, which begins with the first transmission of a new command message 200. In the example of FIG. 2, the originating control device (i.e., the “originator”) is the keypad 130 and the load control system 100 comprises the two signal repeaters 140, 142. The command message 200 is transmitted multiple times, e.g., nine times, as shown in FIG. 2. Preferably, the keypad 130 is operable to change how many times the command message 200 is retransmitted depending upon how many signal repeaters 122 are in the system 100.

The time period between consecutive transmissions of the command message 200 by the control device is defined as a “cycle” and is, for example, 50 msec in length. Each cycle is split up into multiple “slots”, e.g., four slots when there are up to three signal repeaters in the load control system 100. During the first slot of each cycle, the originating control device (i.e., the keypad 130) is operable to transmit the command message 200. During the second and third slots, the two signal repeaters 140, 142 are operable to transmit respective repeater messages 210, 212, which are simply re-transmissions of the original command message 200. If the system 100 included a third signal repeater, the third signal repeater would transmit a repeater message 214 during the fourth slot of each cycle. When the load control system 100 includes more than three signal repeaters, the length of each cycle is increased, such that each cycle comprises five or six slots if the system has four or five signal repeaters, respectively. Preferably, each control device of the load control system 100 determines the number of signal repeaters and the resulting cycle time during configuration of the load control system.

After the command message 200 or the repeater messages 210, 212, 214 are transmitted, there are three ACK sub-slots in each slot in which the control devices of the load control system 100 (e.g., the wall-mounted dimmer 112) may transmit acknowledgement messages 220 in response to the command message 200. Each of the control devices has predetermined ACK sub-slots during which the control device may transmit the acknowledgement message 220. Specifically, each control device is assigned two ACK sub-slots during each command message event. Preferably, the specific ACK sub-slots are determined by each control device during configuration of the load control system.

As the originating control device transmits a specific command message 200 multiple times and the signal repeaters 140, 142 re-transmit the command message via the repeater messages 210, 220 during the command message event, the command message “propagates” through the load control system 100. Therefore, propagation is defined as the initial transmission and subsequent repeated re-transmissions of a single digital message to ensure that the digital message is received by all of the control devices of the load control system. According to the present invention, the control devices of the load control system 100 are operable to begin transmitting the acknowledgement messages 220 before the end of the propagation, i.e., the end of the command message event.

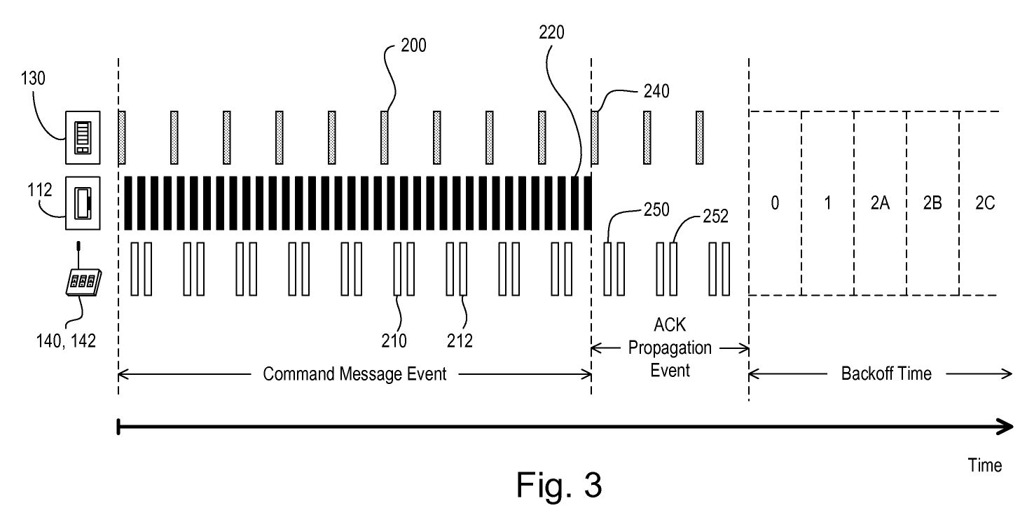

After the end of the command message event, there is a backoff time, which is divided up into six backoff periods (0, 1, 2A, 2B, 2C, 2D), which each have a length of approximately one cycle. The backoff time allows the control devices of the load control system to transmit digital messages in response to the command message 210. FIG. 3 is a simplified timing diagram showing an example of an ACK propagation event transmitted during the backoff time after the command message event. If any of the control devices of the load control system did not receive all of the necessary acknowledgement messages during the command message event, the control device can transmit an ACK propagation message 240 during the first backoff period 0. For example, the originating control device transmits the ACK propagation message 240 during the first backoff period 0 and re-transmits the ACK propagation message 240 during the next two backoff periods. The repeaters 140, 142 re-transmit the ACK propagation message 240 via repeater messages 250, 252. The ACK propagation event is followed by the backoff time.

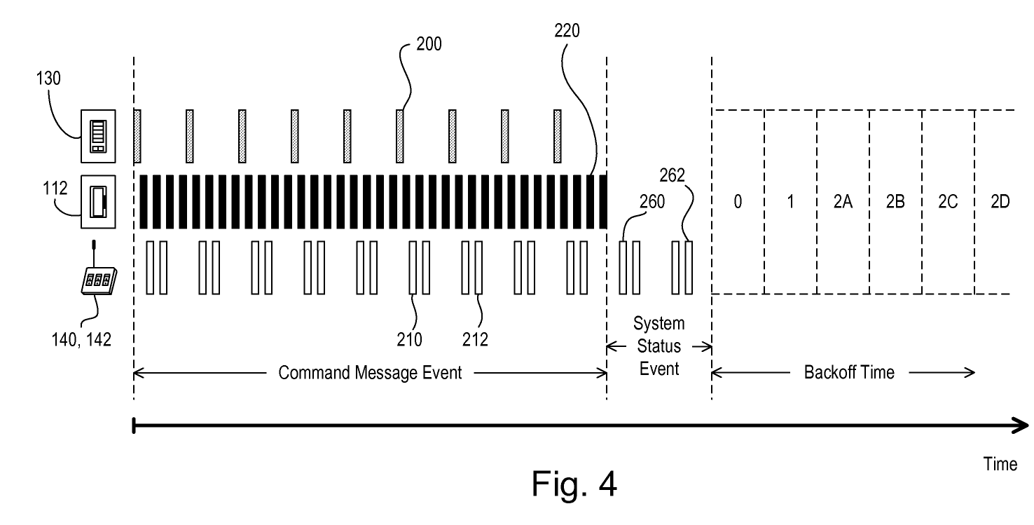

FIG. 4 is a simplified timing diagram showing an example of a system status event transmitted during the backoff time after the command message event. If no control devices transmitted an ACK propagation message 240 during the first backoff period 0, but the status of the system changed in response to the command message event, the main repeater is operable to transmit a system status message 260 during the first backoff period 0. For example, if any of the lighting loads 104, 106 changed states (e.g., from off to on and vice versa), the main repeater uses the database to determine if any of the visual indicators 118, 138 of the dimmer 112 or the keypads 130, 132 need to be adjusted to provide the appropriate feedback to the user of the load control system. If so, the main repeater transmits the system status message 260, which preferably includes information regarding whether each of the visual indicators 118, 138 should be on, off, or blinking. The main repeater transmits system status messages 260 until all of the necessary information is transmitted to the control devices of the load control system 100. The repeaters 140, 142 re-transmit the system status messages 260 via repeater messages 262. The system status event is followed by the backoff time.

If neither an ACK propagation message 240 nor a system status message 260 are transmitted during the first backoff period 0, any of the control devices of the load control system 100 are operable to transmit a priority 1 command message (i.e., begin another command message event) during the second backoff period 1. If this does not occur, the control devices are then operable to begin to transmit a priority 2 command message during one of the remaining backoff periods 2A-2D, which is randomly chosen by the transmitting control device. The priority 2 command messages comprise, for example, command messages that were previously transmitted, but were interrupted during propagation in order to allow the transmission of another higher priority digital message. If the control devices do not transmit any new digital messages during the backoff time, there is a wait period before the RF communication link becomes idle.

According to the present invention, the dimmer 112 and the keypads 130, 132 are operable to quickly transmit first and second command messages in response to subsequent actuations of one of the actuators, for example, presses and releases of raise or lower buttons, or a double tap of one of the preset buttons. Therefore, the resulting system operation (i.e., the control of the intensities of the lighting loads 104, 106) is fast and accurate even if the load control system 100 includes control devices spaced apart over long distances, thus requiring a substantially large number of signal repeaters (e.g., up to five signal repeaters).

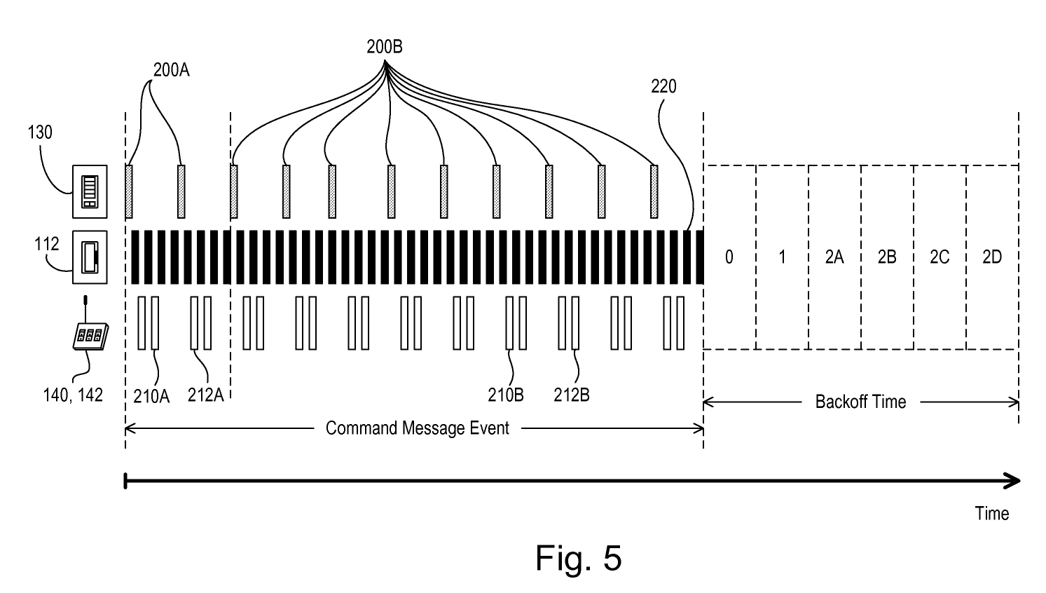

In order to provide this functionality, the originating control device is operable to interrupt the propagation of a first command message 200A to transmit a second command message 200B as shown in FIG. 5. During the transmission of the first command message 200A, the originating control device is operable to determine if the second command message has a higher priority than the first command message. Specifically, the originating control device is operable to determine if the first command message 200A is “irrelevant” in view of the second command message 200B and then “supersedes” the first command message with the second command message. For example, if the second command message 200B is a “lower” (or “stop”) command message (in response to an actuation of the lower button 135), while the first command message 200A is a “raise” command message (in response to an actuation of the raise button 136), the first command message is therefore irrelevant. Accordingly, the keypad 130 is operable to interrupt the propagation of the first command message 200A to transmit the “superseding” command message (i.e., the second command message 200B). Further, if the first command message 200A is a “preset” command message (in response to a first actuation of a preset button 134) and the second command message 200B is a “double-tap” command message (in response to a subsequent second actuation of the preset button 134), the first command message is irrelevant and the keypad 130 is also operable to interrupt the propagation of the first command message to transmit the second command message.

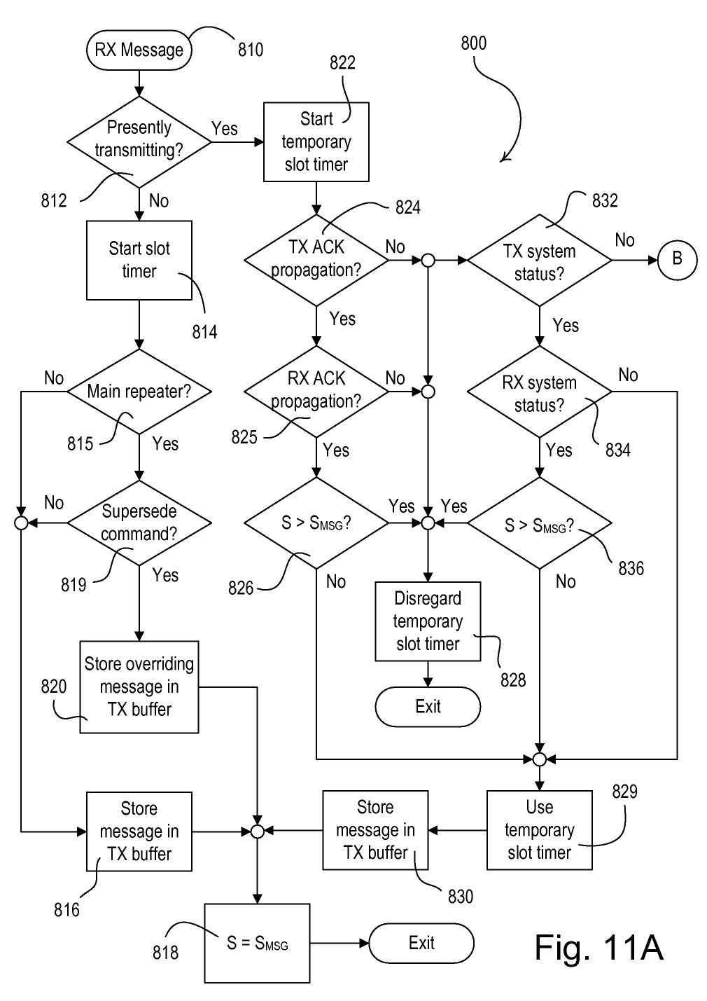

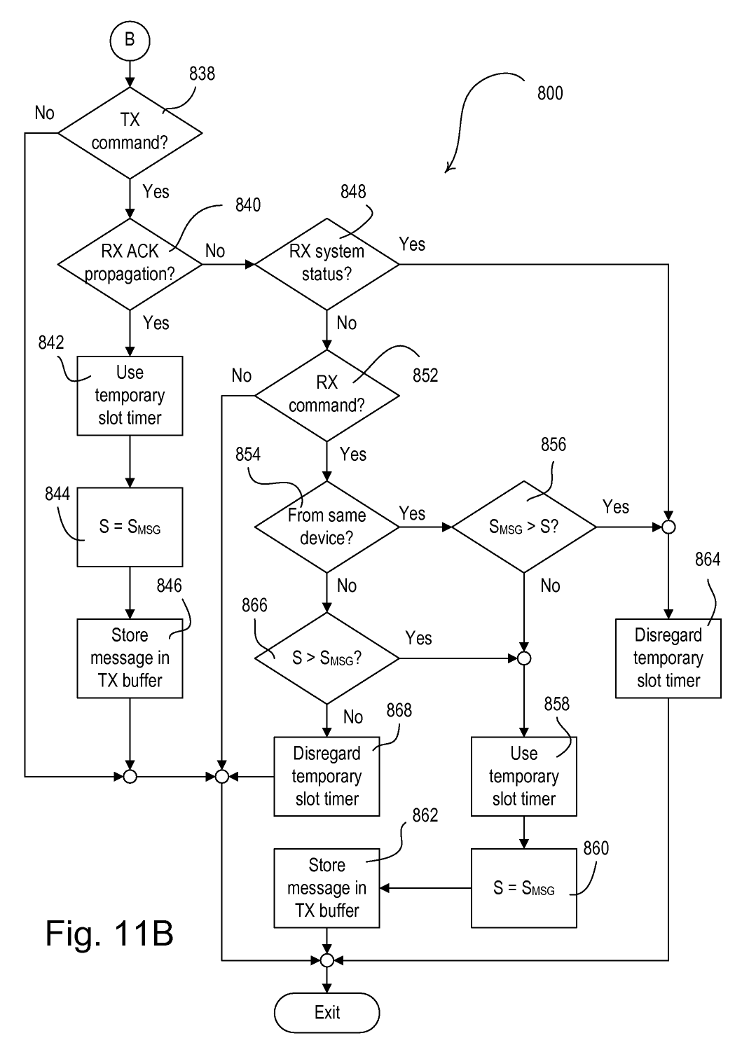

In addition, the signal repeaters 140, 142 are operable to interrupt the propagation of a first command message and essentially replace first command message with a second command message. For example, if two control devices are outside the communication range of each other and begin to transmit the first and second command messages at the same time, one of the signal repeaters 140, 142 is operable to determine which of the two command message to re-transmit, e.g., whichever of the two command messages has a higher priority as will be described in greater detail below with reference to FIGS. 11A and 11B. Further, the main repeater is operable to determine if a received command message should be overridden with another command message. For example, if the keypad 130 transmits a button command message containing information that a specific preset button 134 was pressed, the main repeater is operable to use the database to determine which preset should be selected and then supersede the button command message with an appropriate “preset” command message.

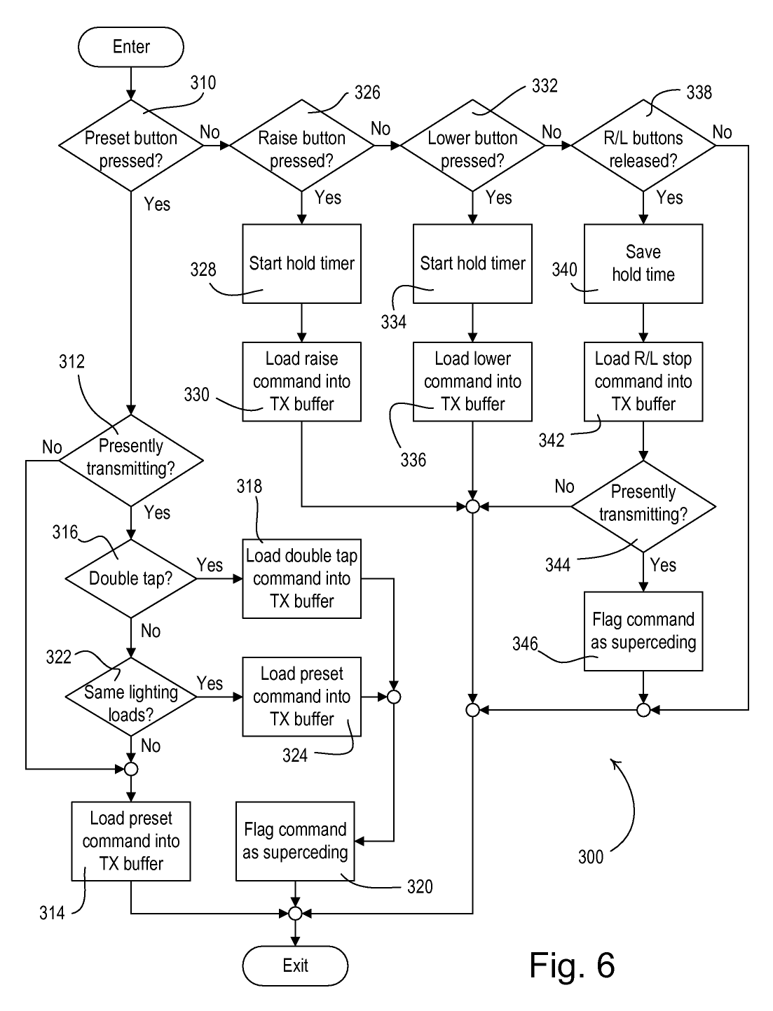

FIG. 6 is a simplified flowchart of a button procedure 300, which is preferably executed periodically by the keypads 130, 132 of the load control system 100, e.g., every 10 msec. During the button procedure 300, the keypads 130, 132 determine what actions to take in response to actuations of one of the preset buttons 134, the raise button 136, or the lower button 138. Specifically, each of the keypads 130, 132 loads an appropriate command message into a transmission (TX) buffer in response to actuations of the buttons. Each digital message loaded into the TX buffer and transmitted by the control devices of the load control system 100 includes the address of the originating control device. While not shown in the figures, the wall-mounted dimmer 112 executes a similar procedure to the button procedure 300 of FIG. 6 in order to determine how to respond to actuations of the control actuator 114 and the intensity adjustment actuator 116.

Referring to FIG. 6, if the first keypad 130 determines that one of the preset buttons 134 has been pressed at step 310 and the first keypad 130 is not presently transmitting a command message at step 312, the keypad loads the appropriate preset command (e.g., preset 1, preset 2, etc.) into the TX buffer at step 314. If the keypad 130 is presently transmitting a command message at step 312, the keypad determines if the actuation of the preset button 134 was a double-tap at step 316. If so, the keypad 130 loads a double-tap command message into the TX buffer at step 318 and flags the double-tap command message as a superseding command message at step 320. If the actuation of the preset button 134 was not a double-tap at step 316, a determination is made at step 322 as to whether the selected preset (in response to the actuation of the preset button) affects the same lighting loads 104, 106 as the command message that is presently being transmitted. If so, the keypad 130 loads an appropriate preset command message into the TX buffer at step 324 and flags the preset command message as a superseding command message at step 320. If the keypad 130 is presently transmitting a command message at step 312, but the actuation of the preset button 134 was not a double-tap at step 316 and the selected preset does not affect the same lighting loads 104, 106 as the command message that is presently being transmitted at step 322, the keypad 130 simply loads an appropriate preset command into the TX buffer at step 314, such that the keypad will transmit the preset command after the keypad is finished transmitting the present command message.

If none of the preset buttons 134 are being pressed at step 310, but the raise button 135 is being pressed at step 326, the keypad 130 clears and starts a hold timer at step 328. The keypad 130 uses the hold timer to measure how long the raise button 135 is pressed and held. At step 330, the keypad 130 loads a raise command message into the TX buffer and the button procedure 300 exits. If raise button 135 is not being pressed at step 326, but the lower button 136 is being pressed at step 332, the keypad 130 initializes the hold timer to zero seconds and starts the hold timer at step 334, and then loads a lower command message into the TX buffer at step 336.

If either the raise button 135 or the lower button 136 have been released at step 338, the keypad 130 determines the value of the hold timer and stores this value (i.e., the hold time) in memory at step 340. The keypad 130 then loads a raise/lower (R/L) stop command message into TX buffer at step 342. The value of the hold time is included in the stop command message loaded in the TX buffer at step 342. For example, when the dimmer 112 receives the stop command message, the dimmer may use the hold time to adjust the intensity of the lighting load 104 if the dimmer overshot or undershot the desired intensity of the lighting load. If the keypad 130 is not presently transmitting at step 344, the button procedure 300 simply exits. Otherwise, the control flags the stop command message as a superseding message at step 346 and the button procedure 300 exits, such that the keypad 130 will interrupt the propagation of the raise or lower command message to transmit the stop command message.

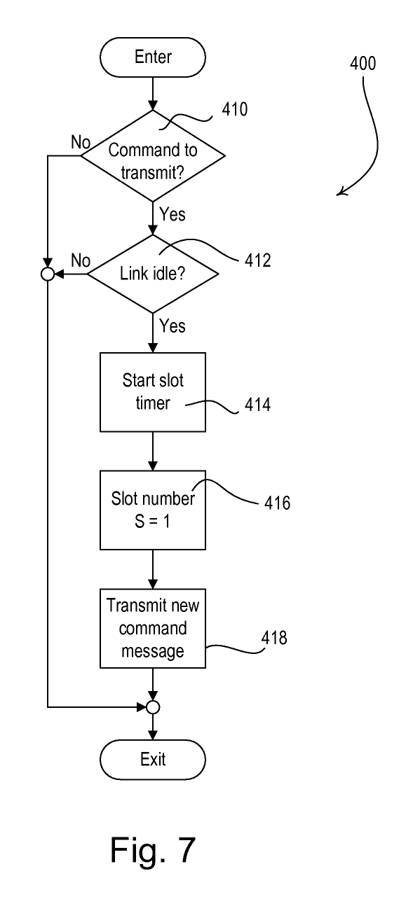

FIG. 7 is a simplified flowchart of a command transmitting procedure 400, which is executed by the wall-mounted dimmer 112 and the keypads 130, 132 of the load control system 100 to begin the transmission of new command messages when the RF communication link is idle. The command transmitting procedure 400 is preferably executed periodically by the dimmer 112 and the keypads 130, 132, e.g., every 10 msec. The control devices use a slot number S to keep track of the present slot and a slot timer to determine when the next slot begins.

The flowchart of the command transmitting procedure 400 of FIG. 7 will be described as executed by the keypad 130. If there are no new command messages to transmit at step 410 or the RF communication link is not idle at step 412, the command transmitting procedure 400 simply exits without initiating the transmission of a new command message. However, if there is a new command message to transmit at step 410 and the RF communication link is idle at step 412, the keypad 130 initializes the slot timer to zero seconds and starts the slot timer at step 414. The keypad 130 sets the slot number S to one at step 416 and transmits the new command message for the first time at step 418 before the command transmitting procedure 400 exits. Preferably, every command message and repeater message contains a message slot number S_{MSG}, which is equal to the slot number during which the command message 200 or repeater message 210 was transmitted.

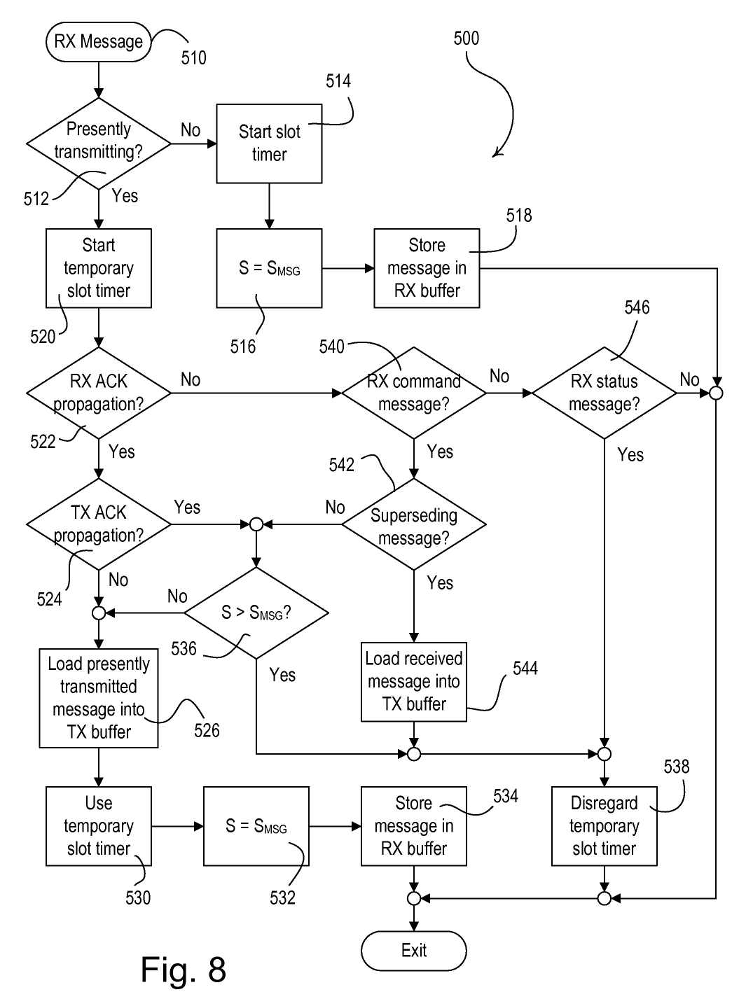

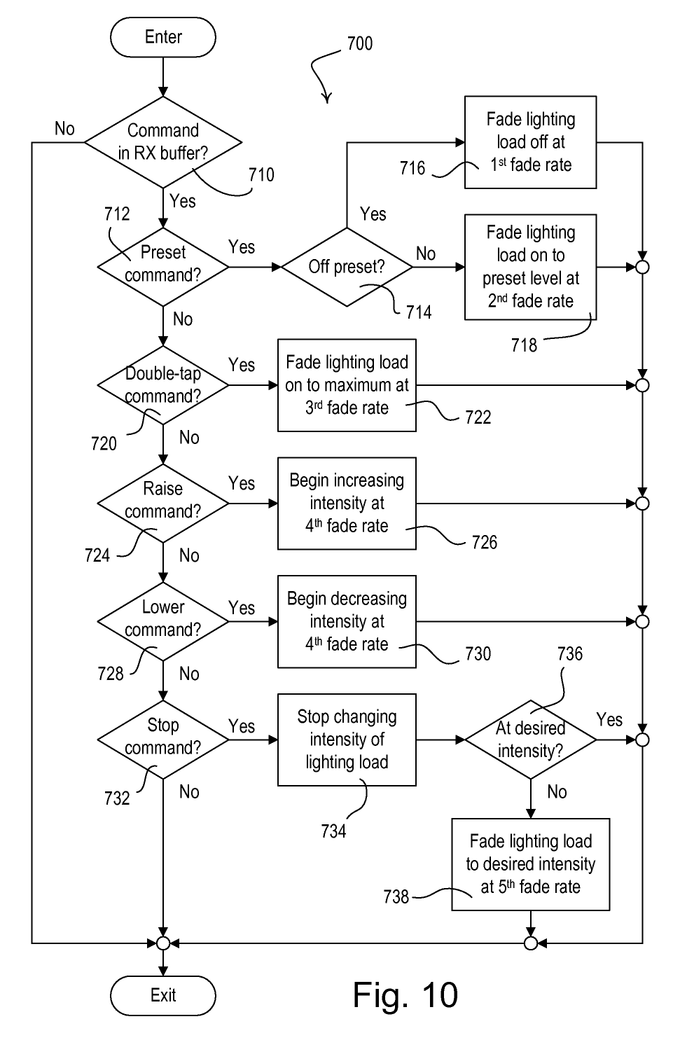

FIG. 8 is a simplified flowchart of a message receiving procedure 500, which is executed by each of the control devices of the load control system 100 the first time that the control device receives a new digital message. The message reception procedure 500 allows each control device to decide whether the control device should synchronize to the slot timer and the slot number S to the respective values of the received digital message. The control devices use a receiving (RX) buffer to store the received digital message, such that the control devices can process the digital message (e.g., the commands from command messages) at a later time, which will be described with reference to FIG. 10.

The flowchart of the message receiving procedure 500 of FIG. 8 will be described as executed by the wall-mounted dimmer 112. After receiving the new digital message at step 510, the dimmer 112 determines if the dimmer is presently transmitting a digital message on the RF communication link at step 512. If not, the dimmer 112 starts the slot timer at the beginning of the received digital message at step 514 and sets the slot number S to the slot number S_{MSG} that is included in the received digital message at step 5 16. Finally, the dimmer 112 stores the received digital message in the RX buffer at step 518 and the receiving procedure 500 exits.

If the dimmer 112 receives a new digital message at step 510 when the dimmer is presently transmitting a digital message at step 512, the dimmer starts a temporary slot timer at step 520. The temporary slot timer allows the dimmer 112 to be able to synchronize any subsequently transmitted digital messages to the received digital message if the received digital message has a higher priority than the digital message that the dimmer is presently transmitting (as will be described below).

Preferably, an ACK propagation message has a higher priority than a command message or a system status message. Therefore, if the dimmer 112 determines that an ACK propagation message 240 was received at step 522 and an ACK propagation message is presently not being transmitted at step 524, the dimmer synchronizes to the received ACK propagation message. Specifically, the dimmer 112 loads the command message that is presently being transmitted into the TX buffer at step 526. Accordingly, the dimmer 112 will re-transmit the command message loaded into the TX buffer at step 526 after the transmission of the newly received ACK propagation message is complete. The dimmer 112 then decides to use the temporary slot timer at step 530, sets the slot number S to the slot number S_{MSG} from the received command message at step 532, and stores the received message in the RX buffer at step 534. If the dimmer 112 has received an ACK propagation message 240 at step 522, but is presently transmitting an ACK propagation message at step 526, a determination is made at step 536 as to whether the slot number S of the transmitted ACK propagation message is greater than the slot number S_{MSG} of the ACK propagation command message. If so, the dimmer 112 decides to continue with the transmitted ACK propagation message by disregarding the temporary slot timer at step 538, and the message receiving procedure 500 exits. Otherwise, the dimmer 112 uses the temporary slot timer at step 530, sets the slot number S to the slot number S_{MSG} from the received command message at step 532, and stores the received message in the RX buffer at step 534, before the message receiving procedure 500 exits.

A command message preferably has a higher priority than a system status message. Therefore, if an ACK propagation message 240 is not received at step 522, but command message is received at step 540, the dimmer 112 determines whether the dimmer should synchronize to the newly received command message. According to the operation of the load control system 100, the main repeater is operable to determine that a second command message should supersede an initial command message transmitted by the dimmer 112 (as will be described in greater detail below with reference to FIGS. 11A and 11B). At step 542, the dimmer 112 determines if the received command message was transmitted by the main repeater and should supersede the command message that the dimmer is presently transmitting. If so, the dimmer 112 loads the received command message into the TX buffer at step 544 and disregards the value of the temporary slot timer at step 538, before the message receiving procedure 500 exits. Accordingly, the dimmer 112 continues to use the value of the slot timer that was started when the dimmer first began transmitting the present command message (at step 414 of FIG. 7).

If the received command message is not a superseding message at step 542, the dimmer 112 determines at step 536 if the slot number S of the transmitted command message is greater than the slot number S_{MSG} of the received command message at step 536. If so the dimmer 112 disregards the value of the temporary slot timer at step 538 and the message receiving procedure 500 exits. If the received command message is not a superseding message at step 542 and does not have a higher slot number S than the transmitted command message at step 536, the dimmer 112 loads the command message that is presently being transmitted into the TX buffer at step 526. Accordingly, the dimmer 112 will re-transmit the command message loaded into the TX buffer at step 526 after the transmission of the newly received command message is complete. The dimmer 112 then decides use the temporary slot timer at step 530, sets the slot number S to the slot number S_{MSG} from the received command message at step 532, and stores the received message in the RX buffer at step 534.

If the dimmer 112 did not receive a command message at step 540, but received a status message at step 546, the dimmer simply disregards the temporary slot number at step 538 and the message receiving procedure 500 exits.

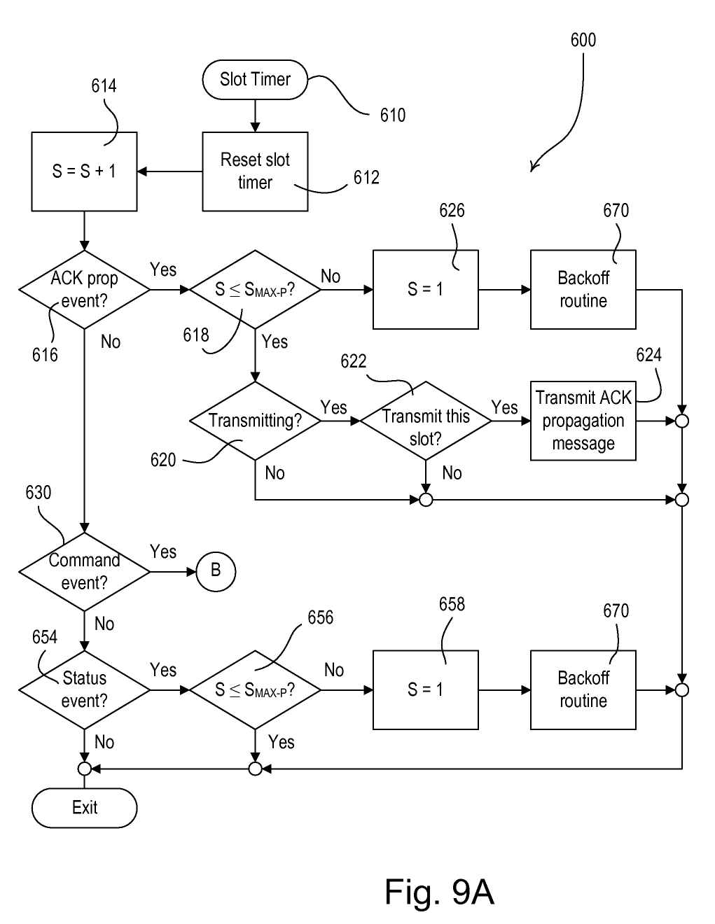

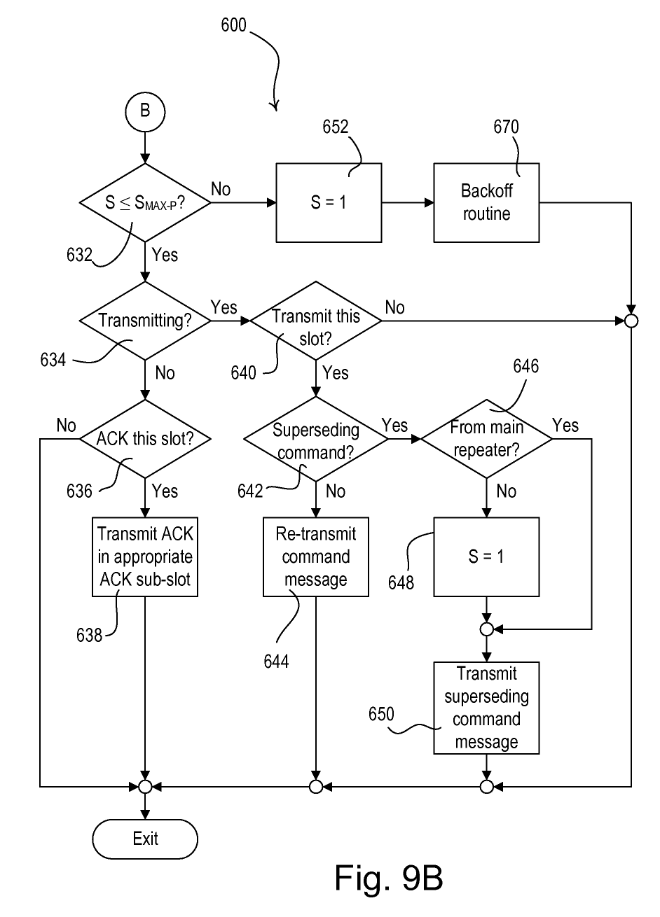

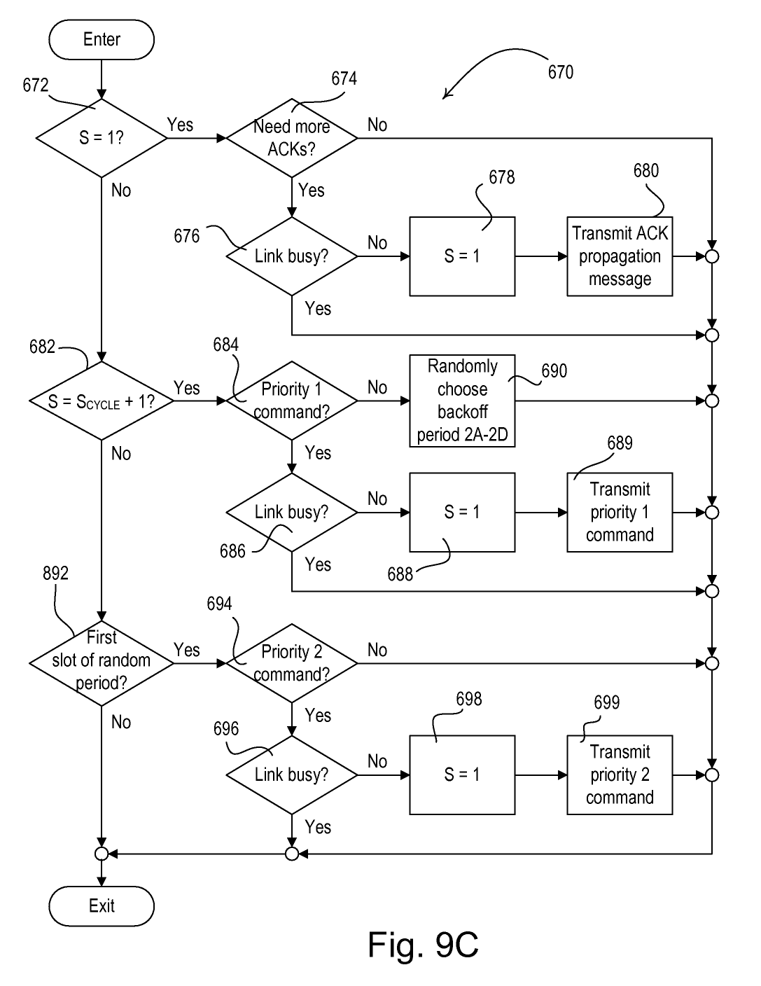

FIGS. 9A and 9B are simplified flowcharts of a slot procedure 600, which is executed by each of the control devices of the load control system 100 during each “slot” as shown in FIGS. 2-5. The keypad 130 uses a predetermined number S_{CYCLE} of slots per cycle, which is determined during configuration of the load control system 100 in response to the number of signal repeaters 140, 142 present in the load control system. Preferably, the number S_{CYCLE} equals four (4) if there are up to three signal repeaters, five (5) if there are four signal repeaters, and six (6) if there are five signal repeaters. The flowcharts of the slot procedure 600 of FIGS. 9A and 9B will be described as executed by the keypad 130.

Referring to FIG. 9A, the slot procedure 600 begins at step 610, when the slot timer exceeds a slot period length T_{SLOT}, e.g., 12.5 msec, when the load control system 100 has two signal repeaters 140, 142. First, the keypad 130 resets the slot timer to zero seconds at step 612, and increments the slot number S by one at step 614. If the keypad 130 is presently in the middle of an ACK propagation event at step 616, the keypad determines at step 618 if the slot number S is less than or equal to a maximum ACK propagation event slot number S_{MAX-P} to determine if the end of the ACK propagation event has been reached. If the ACK propagation event is still occurring at step 618, if the keypad 130 is presently transmitting the ACK propagation messages at step 620, and if the keypad should transmit this slot at step 622, the keypad transmits the ACK propagation message at step 624, before the slot procedure 600 exits. When the slot number S is greater than the maximum ACK propagation event slot number S_{MAX-P} at step 618, the keypad 130 sets the slot number to one at step 626 and executes a backoff routine, which is described in greater detail below with reference to FIG. 9C.

Referring to FIG. 9B, if the keypad 130 is presently in the middle of a command message event at step 630, the keypad determines at step 632 if the end of the command message event has arrived. Specifically, if the slot number S is less than or equal to a maximum command message event slot number value S_{MAX-C} at step 632 and the keypad 130 is not presently transmitting a command message at step 634, the keypad determines if the keypad should transmit an acknowledgement message 220 during any of the ACK sub-slots of the present slot at step 636. If so, the keypad 130 transmits an acknowledgement message 220 during the appropriate ACK sub-slot at step 638.

If the keypad 130 is presently transmitting at step 634, but the present slot is not the slot in which the keypad should re-transmit the command message at step 640, the slot procedure 600 simply exits. However, if the keypad 130 should re-transmit the command message during the present slot at step 640 and the TX buffer does not contain a command message that is flagged as a superseding command message at step 642, the keypad simply re-transmits at step 644 the present command message (i.e., the command message that was originally transmitted at step 418 of FIG. 7), before the slot procedure 600 exits.

If the keypad 130 determines at step 642 that the TX buffer contains a command message that is flagged as a superseding command message, but determines at step 646 that the command message in the TX buffer was not received from the main repeater, the keypad interrupts the propagation of the original command message to transmit the superseding command message. Accordingly, the slot number S is set to one at step 648 and the keypad 130 transmits the new command message at step 650 for the first time (i.e., as shown by the second command message 200B in FIG. 5). However, if the command message in the TX buffer was received from the main repeater at step 646, the keypad 130 continues to use the present slot number S and simply begins to transmit at step 650 the superseding command message from the TX buffer rather than the command message that the keypad 130 was transmitting.

If the slot number S is greater than the maximum command message event slot number value S_{MAX-C} at step 632, the keypad 130 is finished transmitting the command message event and is in the backoff period. The keypad 130 sets the slot number S to one at step 652 and executes the backoff routine 670.

Referring back to FIG. 9A, if the keypad 130 is presently in the middle of a command message event at step 654, a determination is made at step 656 as to whether the slot number S is less than or equal to a maximum system status event slot number value S_{MAX-S}. If so, the slot procedure 600 simply exits. Otherwise, the keypad 130 sets the slot number equal to one at step 658 and executes the backoff routine 670.

FIG. 9C is a simplified flowchart of the backoff routine 670. If the slot number S is equal to one at step 672, the keypad 130 is operable to transmit an ACK propagation message 240 during the first backoff cycle 0. Specifically, if the keypad 130 needs to receive more acknowledgement messages 220 at step 674 and the RF communication link is not busy at step 676, the keypad sets the slot number equal to one at step 678 and transmits an ACK propagation message 240 during the first backoff cycle 0 at step 680. If the keypad 130 does not need any more acknowledgement messages 220 at step 674, the backoff routine 670 simply exits.

When the backoff routine 670 is executed during the second backoff period 1, the keypad 130 is operable to transmit a priority 1 command message. Specifically, if the slot number S is equal to the predetermined number S_{CYCLE} of slots per cycle plus one at step 682, a determination is made as to whether the keypad 130 has a priority 1 command message to transmit at step 684. If the keypad 130 has a priority 1 command message to transmit at step 684 and the RF communication link is not busy at step 648, the keypad sets the slot number S to one at step 688 and transmits the priority 1 command message at step 689.

If the keypad 130 does not transmit a priority 1 command message during the second backoff period 1, the keypad is operable to transmit a priority 2 command message during one of the remaining backoff periods 2A-2D. If the keypad 130 does not have a priority 1 command message to transmit at step 684, the keypad randomly chooses one of the remaining backoff periods 2A-2D at step 690 before the backoff routine 670 exits. When the backoff routine 670 is executed after the second backoff period 1, a determination is made at step 692 as to whether the preset slot is the first slot of the randomly-chosen backoff period. If so, the keypad 130 determines if there is a priority 2 command message to transmit at step 694 and if the RF communication link is busy at step 696. If the keypad 130 does not have a priority 2 command message to transmit at step 694 or the link is busy at step 696, the backoff routine 670 simply exits. Otherwise, the keypad 130 sets the slot number S equal to one at step 698 and transmits the priority 2 command message at step 699, before the backoff routine 670 exits.

FIG. 10 is a simplified flowchart of a processing procedure 700 executed periodically by the wall-mounted dimmer 112 and the remote dimming module 120, e.g., every 10 msec. The processing procedure 700 allows the dimmer 112 and the remote dimming module 120 to respond to received command messages stored in the RX buffer. The flowchart of the processing procedure 700 of FIG. 10 will be described as executed by the wall-mounted dimmer 112.

Referring to FIG. 10, if there are no command messages stored in the RX buffer at step 710 the processing procedure 700 simply exits. If the dimmer 112 has received a preset command at step 712 and the preset command is an off preset command at step 714, the dimmer 112 begins to “fade” the lighting load 104 from the present intensity to off (i.e., slowly control the intensity of the lighting load to 0% intensity) at a first fade rate (e.g., approximately 0.45% of the dimming range per millisecond) at step 716. If the present command is not an off preset command at step 714, the dimmer 112 begins to fade the lighting load 104 on to the appropriate preset intensity level at a second fade rate at step 718. The second fade rate is preferably faster than the first fade rate, for example, approximately 1.33% of the dimming range per millisecond, such that the lighting load 104 turns on quicker than the lighting load turns off. If the dimmer 112 did not receive a preset command at step 712, but received a double-tap command at step 720, the dimmer 112 begins to fade the lighting load 104 on to the maximum intensity (e.g., 100%) at a third fade rate at step 722. Preferably, the third fade rate is faster than the first and second fade rates, for example, approximately 2.00% of the dimming range per millisecond.

If the dimmer 112 receives a raise command at step 724, the dimmer begins to increase the intensity of the lighting load 104 at a fourth fade rate (e.g., approximately 0.33% of the dimming range per millisecond) at step 726. Similarly, if the dimmer 112 receives a lower command at step 728, the dimmer begins to decrease the intensity of the lighting load 104 at the fourth fade rate at step 730. When the dimmer 112 receives a stop command at step 732, the dimmer immediately stops changing the intensity of the lighting load 734. The dimmer 112 then determines the desired intensity from the hold time that is transmitted with the stop command and compares the desired intensity to the actual present intensity at step 736. If the actual present intensity is equal to the desired intensity at step 736, the processing procedure 700 simply exits. However, if the actual present intensity is not equal to the desired intensity at step 736 (i.e., the dimmer 112 overshot or undershot the intensity), the dimmer fades the lighting load 104 to the desired intensity at a fifth fade rate (e.g., approximately 0.08% of the dimming range per millisecond) at step 738. Preferably, the fifth fade rate is substantially slow such that a user of the load control system 100 does not notice that the intensity of the lighting load 104 is changing.

Accordingly, when the raise button 135 of the keypad 130 is first pressed, the keypad 130 determines that the raise button has been pressed during the button procedure 300 and then transmits a first command message 200A during the command transmitting procedure 400. The slot procedure 600 then begins to execute during each slot (as shown in FIG. 2). When the dimmer 112 receives the first command message 200A, the dimmer loads the raise command into the RX buffer during the message receiving procedure 500. During the processing procedure 700, the dimmer 112 begins to increase the intensity of the lighting load 104 (at step 726). When the raise button 135 of the keypad 130 is released, the keypad 130 loads a stop command into the TX buffer and flags the stop command as a superseding command message during the button procedure 300. During the slot procedure 600, the keypad 130 determines that there is a superseding command message in the TX buffer (at step 642) and the keypad begins to transmit the second superseding command message 200B rather than the first command message 200A (at step 650). The dimmer 112 then quickly receives the second command message 200B during the message receiving procedure 500 and stops changing the intensity of the lighting load 104 during the processing procedure (at step 734). If the dimmer 112 did overshoot the desired intensity, the dimmer is able to correct the intensity of the lighting load 104 to the correct intensity (at step 738).

Similarly, if a preset button 134 of the keypad 130 is actuated, the keypad 130 loads a preset command into the TX buffer during the button procedure 300, transmits a first command message 200A during the command transmitting procedure 400, and begins to execute the slot procedure 600 during each slot. The dimmer 112 receives the first command message 200A and loads the preset command into the RX buffer during the message receiving procedure 500. If the dimmer 112 is programmed to turn off the lighting load 104 in response to the preset command (i.e., an off preset), the dimmer begins to fade the lighting load off at the first fade rate during the processing procedure 700 (at step 716). If the preset button 134 of the dimmer is actually double-tapped, the keypad 130 loads a “double-tap” command into the TX buffer and flags the “double-tap” command as a superseding command message during the button procedure 300. During the slot procedure 600, the keypad 130 determines that there is a superseding command message in the TX buffer (at step 642) and the keypad begins to transmit the second superseding command message 200B rather than the first command message 200A (at step 650). The dimmer 112 quickly receives the second command message 200B during the message receiving procedure 500 and controls the intensity of the lighting load 104 to the maximum intensity during the processing procedure (at step 722).

FIGS. 11A and 11B are simplified flowcharts of a repeater receiving procedure 800 executed by each of the signal repeaters 140, 142 of the load control system 100 when a new digital message is received at step 810. Referring to FIG. 11A, if the first signal repeater 140 is presently transmitting a digital message at step 812, the signal repeater starts the slot timer at step 814. If the signal repeater 140 is not configured as the main repeater at step 815, the signal repeater stores the received digital message in the TX buffer at step 816, so that the signal repeater can re-transmit the digital message during the appropriate slot. The signal repeater 140 then sets the slot number S to the slot number S_{MSG} that is included in the received message at step 818.

If the signal repeater 140 is configured as a main repeater at step 815, the signal repeater is operable to determine at step 819 if a second command message should supersede the received command message. For example, if the received command message is a button command message, the main repeater uses the database to determine what command message, e.g., a specific preset command message, should be transmitted instead of (i.e., should supersede) the received button message. If a second command message should supersede the received command message at step 819, the signal repeater stores the superseding command message in the TX buffer at step 820.

If the signal repeater 140 is presently transmitting a digital message that is different than the received digital message at step 812, the signal repeater first starts a temporary slot timer at step 822 and then determines which of the two messages (i.e., the transmitted message and the received message) has a higher priority and will be thus re-transmitted to the control devices of the load control system 100. If the transmitted message is an ACK propagation message at step 824, but the received message is not an ACK propagation message at step 825, the signal repeater 140 disregards the temporary slot timer at step 828 and the repeater receiving procedure 800 exits, such that the signal repeater continues to re-transmit the transmitted message. If the transmitted message and the received message are ACK propagation messages at steps 824, 825, the signal repeater 140 decides to re-transmit the “older” digital message, i.e., the digital message that has the higher slot number. Specifically, if the slot number S of the transmitted message is greater than the slot number S_{MSG} of the received message at step 826, the signal repeater 140 disregards the temporary slot timer at step 828 and the repeater receiving procedure 800 exits. On the other hand, if the slot number S of the transmitted message is less than the slot number S_{MSG} of the received message at step 826, the signal repeater 140 decides at step 829 to use the temporary slot timer for continued communication, before storing the received message in the TX buffer at step 830 and setting the slot number S equal to the slot number S_{MSG} of the received message at step 818.

If the transmitted message is not an ACK propagation message at step 824, but is a system status message at step 832, a determination is made at step 834 as to whether the received message is a system status message. If the transmitted message and the received message are system status messages at steps 832, 834, the signal repeater 140 determines which of the transmitted message and the received message has a larger slot number at step 836. If the slot number S of the transmitted message is greater than the slot number S_{MSG} of the received message at step 836, the signal repeater 140 disregards the temporary slot timer at step 828 and the repeater receiving procedure 800 exits. If the slot number S of the transmitted message is greater than the slot number S_{MSG} of the received message at step 836 or if the received message is not a system status message at step 834, the signal repeater 140 decides to use the temporary slot timer at step 829, stores the received message in the TX buffer at step 830, and sets the slot number S equal to the slot number S_{MSG} of the received message at step 818, before the repeater receiving procedure 800 exits.

Referring to FIG. 11B, if the transmitted message is not a system status message at step 832, a determination is made at step 838 as to whether the transmitted message is a command message. If the transmitted message is a command message at step 838 and the received message is an ACK propagation message at step 840, the signal repeater re-transmits the newly received message by using the temporary slot timer at step 842, setting the slot number S to the slot number S_{MSG} of the received message at step 844, and storing the received message in the TX buffer at step 846. If the transmitted message is a command message at step 838 and the received message is a system status message at step 848, the signal repeater 140 disregards the temporary slot timer at step 850 and the repeater receiving procedure 800 exits.

If both the transmitted and received messages are command messages at steps 838, 852, the signal repeater 140 determines whether the transmitted and received messages are both from the same control device at step 854. If so, the signal repeater re-transmits the newer of the two command messages. Specifically, if the slot number S_{MSG} of the received message is smaller than the slot number S of the transmitted message at step 856, the signal repeater 140 uses the temporary slot timer at step 858, sets the slot number equal to the slot number S_{MSG} from the received message at step 860, and stores the received message in the TX buffer at step 862. Otherwise, the signal repeater 140 disregards the temporary slot timer at step 864. If the transmitted and received messages are from different control devices at step 854, the signal repeater 140 determines which of the transmitted and received messages has the larger slot number at step 866. Specifically, if the slot number S of the transmitted message is not larger than the slot number S_{MSG} of the received message at step 866, the signal repeater 140 disregards the temporary slot timer at step 868. Otherwise, the signal repeater 140 decides to use the temporary slot timer at step 858, sets the slot number S to the slot number S_{MSG} of the received message at step 860, and stores the received message in the TX buffer at step 862.

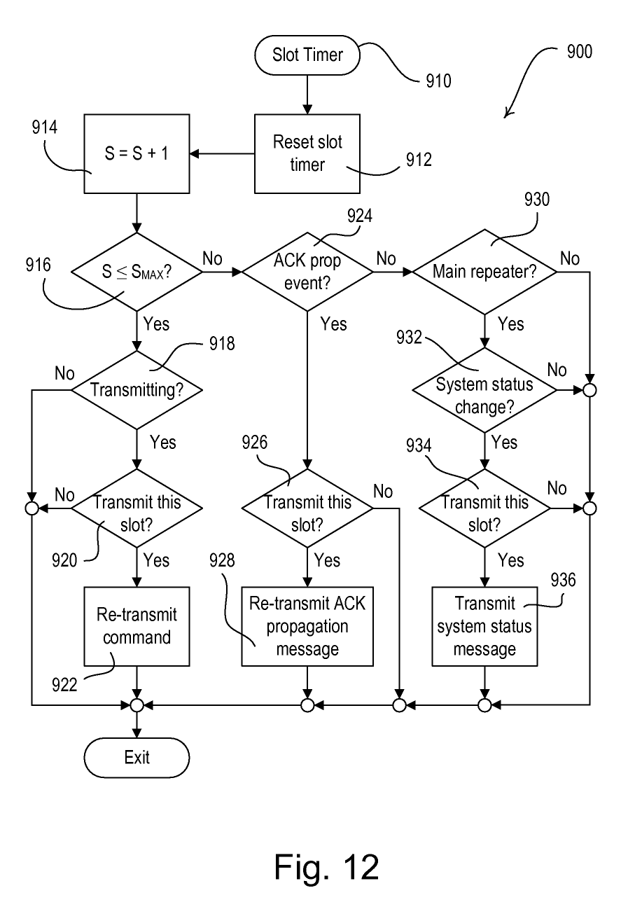

FIG. 12 is a simplified flowchart of a repeater slot procedure 900, which is executed by each of the signal repeaters 140, 142 of the load control system 100 during each “slot” as shown in FIGS. 2-5. Referring to FIG. 12, the first signal repeater 140 executes the repeater slot procedure 900 when the slot timer exceeds the slot period length T_{SLOT}, i.e., 12.5 sec, at step 910. The signal repeater 140 resets the slot timer to zero at step 912 and increments the slot number S by one at step 914. If the slot number S is less than or equal to the maximum slot number value S_{MAX} at step 916, but the signal repeater 140 is not presently in the middle of re-transmitting any command messages at step 918, the repeater slot procedure 900 simply exits. However, if the signal repeater 140 is presently transmitting at step 918 and the signal repeater should transmit during the present slot at step 920, the signal repeater retransmits the digital message stored in the TX buffer at step 922.

If the slot number S is greater than the maximum slot number value S_{MAX} at step 916 (i.e., during the backoff period), the signal repeater 140 determines if an ACK propagation message 240 has been transmitted at step 924. If an ACK propagation message 240 was transmitted at step 924 and the signal repeater 140 should transmit during the present slot at step 926, the signal repeater re-transmits the ACK propagation message at step 928.

If the signal repeater 140 did not receive an ACK propagation message 240 at step 930, a determination is made at step 930 as to whether the signal repeater 140 is configured as a main repeater, i.e., whether the signal repeater 140 should transmit a system status message. If the signal repeater 140 is configured as a main repeater at step 930, but the system status has not changed at step 932 (i.e., none of the visual indicators 118, 138 should be updated), the repeater slot procedure 900 simply exits. However, if the system status has changed at step 932 and the signal repeater 140 should transmit during the present slot at step 934, the signal repeater transmits the system status message at step 936 and the repeater slot procedure 900 exits. As the repeater slot procedure continues to periodically execute, the signal repeater 140 continues to transmit the system status messages at step 936 until the signal repeater no longer has additional system status information to transmit.

Therefore, the signal repeaters 140, 142 are also operable to interrupt the propagation of a first digital message by transmitting a second digital message that has a higher priority than the first digital message.

While the present invention has been described with reference to a time-based communication technique, the method of the present invention could be applied to other types of communication techniques and communication networks, such as, for example, mesh networks. The control devices of an RF mesh network do not transmit digital messages during predetermined time slots. Alternatively, the control devices are operable to begin transmitting a new digital message after a random amount of time after the end of the last transmitted digital message on the RF communication link.

The control devices of an RF mesh network are each operable to originate digital messages and to operate as signal repeaters, i.e., to retransmit received digital messages. The control devices are each assigned unique device addresses for use during communication. Preferably, each new digital message transmitted by the control devices comprises a new sequence number, which is also included with each re-transmission of the digital message. The control devices comprise routing tables, which are built during the initial configuration of the RF mesh network and define how digital messages move from one device to another device through the mesh network. For example, if control device A receives a digital message intended for control device B, the control device A is operable to use the routing table to determine that the received digital message should be re-transmitted to control device C. As each control device in the mesh network re-transmits the digital message based on the routing table, the digital message propagates through the mesh network to the intended receiving control device.

A receiving control device is operable to transmit an acknowledgement message to the originating control device in response to receiving a digital message that includes the device address of the control device. The control devices are also operable to listen to re-transmissions of digital messages to ensure that transmitted digital messages are received. For example, if control device A transmits a digital message to control device B and control device B re-transmits the digital message to control device C, control device A is operable to listen to the digital message re-transmitted by control device B to ensure that control device B received the digital message that control device A transmitted.

The control devices of the RF mesh network are also operable to transmit broadcast digital messages (i.e., to all control devices) or multicast command messages (i.e., to a group of control devices). For example, the control devices may use multicast digital messages to transmit raise, lower, or stop command messages to only the dimmers and load control devices of the mesh network that are affected by the specific command message. Each control device is operable to re-transmit a received broadcast or multicast message to all control devices within the communication range of the control device. Therefore, each control device maintains a list of all of the control devices within the communication range of the control device. When each control device receives a broadcast or multicast message, the control device is operable to ensure that each device within the communication range receives the broadcast or multicast message.

If an originating control device has a superseding digital message to transmit, the originating control device will transmit a new digital message containing the superseding digital message along with specific instructions that this digital message supersedes the old “superseded” digital message. For example, the superseding digital message may include the sequence number of the superseded digital message. Accordingly, any control devices that receive the superseding digital message will cancel any pending re-transmissions of the superseded digital message and will no longer continue to ensure that other control devices have received the superseded digital message.

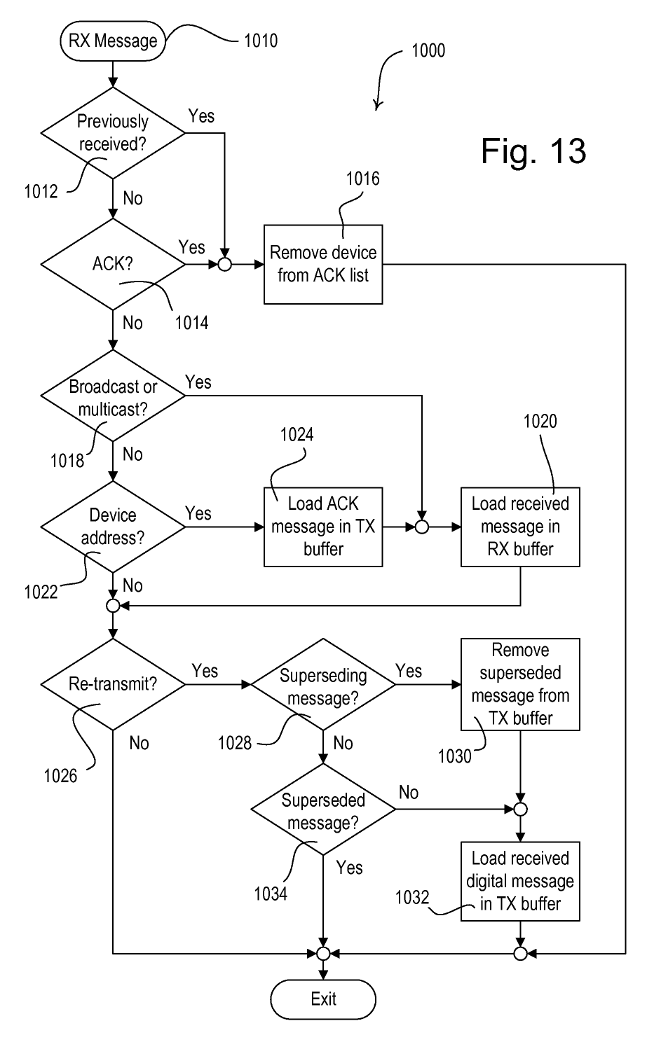

FIG. 13 is a simplified flowchart of a receiving procedure 1000 executed by a control device of a mesh network according to a second embodiment of the present invention. The receiving procedure 1000 allows the control device to decide whether to process a received digital message and whether to re-transmit the received digital message. The receiving procedure 1000 also allows the control device to keep track of the other control devices that have received the digital messages transmitted by the control device. Specifically, the control device maintains an ACK list for each transmitted digital message. The ACK list includes each control device from which a re-transmission or an acknowledgement message is expected (e.g., all of the control devices within the communication range for a broadcast message). If a specific control device is still listed in the ACK list after a predetermined amount of time after the transmission (or reception) of a digital message, the transmitting control device re-transmits the digital message to the specific control device. The transmitting control device therefore keeps each digital message in the TX buffer until the control device is sure that each intended recipient received the digital message.

The receiving procedure 1000 is executed in response to receiving a new digital message at step 1010. If the received digital message is a digital message that was previously received by the control device (i.e., is now being re-transmitted by another control device) at step 1012, or is an acknowledgement message at step 1014, the control device removes the device address of control device that transmitted the digital message from the ACK list at step 1016, and the receiving procedure 1000 exits. If the received digital message is a broadcast or multicast digital message at step 1018, the control device loads the received digital message into the RX buffer at step 1020. If the received digital message has a target address that is equal to the device address of the control device at step 1022, the control device loads an acknowledgement message into the TX buffer at step 1024 and then loads the received digital message into the RX buffer at step 1020.

Next, the control device determines if the received digital message should be re-transmitted at step 1026. If the received digital message should be re-transmitted at step 1026 and the received digital message includes an indication that the digital message is a superseding message at step 1028, the control device removes the superseded message from the TX buffer at step 1030, and loads the superseding message into the TX buffer at step 1032. Therefore, if the control device has not yet re-transmitted the superseded message, the control device will not re-transmit the superseded message. If the control device has already transmitted the superseded message, the control device will no longer continue to ensure that the other control devices are receive the superseded message (i.e., will not re-transmit the superseded message if one or more control devices did not receive the superseded message).

If the received message is not a superseding message at step 1028, a determination is made as to whether the received message was previously superseded at step 1034 (i.e., the control device received the superseding digital message before the control device received the superseded digital message). If so, the receiving procedure 1000 simply exits, thus ignoring the superseded digital message. If the received digital message is not a superseded message at step 1034, the control device loads the received message into the TX buffer at step 1032 and the receiving procedure 1000 exits.

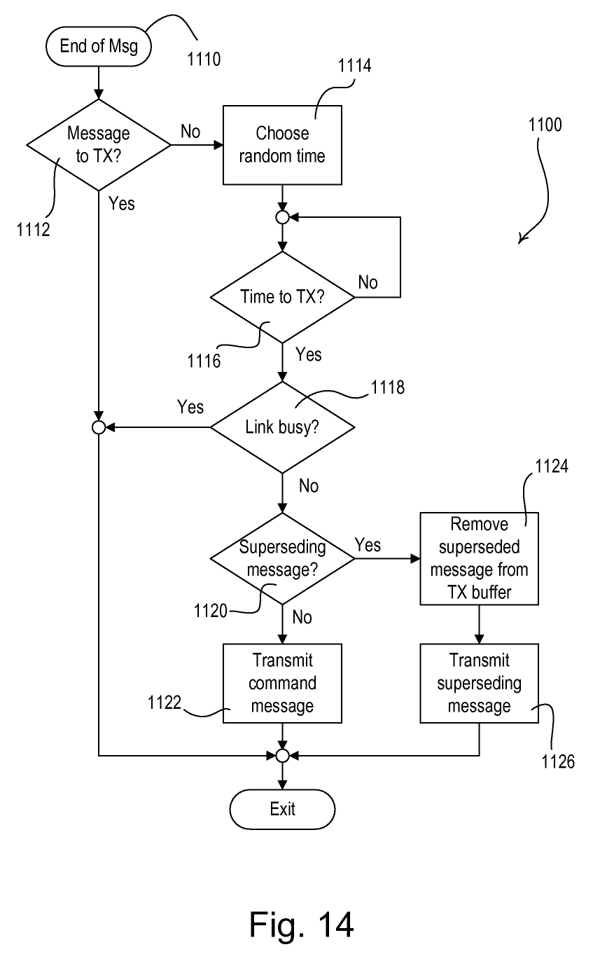

FIG. 14 is a simplified flowchart of a transmitting procedure 1100 executed by the control device of the mesh network according to the second embodiment of the present invention. The transmitting procedure 1100 is executed by each of the control devices of the mesh network at the end of a received digital message at step 1110. For example, all of the control devices may synchronize to a stop bit of the received digital message. If the control device does not have a digital message to transmit at step 1112, the transmitting procedure 1100 simply exits.

However, if the control device has a digital message to transmit at step 1112, the control devices chooses a random amount of time (e.g., up to 64 msec) at step 1114. After the random amount of time has passed at step 1116, a determination is made as to whether the communication link is busy at step 1118 (i.e., another control device is presently transmitting). If so, the transmitting procedure 1100 simply exits. If the link is not busy at step 1118 and the control device does not have a superseding message to transmit at step 1120, the control device transmits the digital message at step 1122 and the transmitting procedure 1100 exits. If the control device has a superseding message to transmit at step 1120, the control device removes the superseded message from the TX buffer at step 1124 and transmits the superseding digital message at step 1126. Specifically, the control device includes information that the superseding digital message replaces the superseded digital message. For example, the sequence number of the superseded digital message is included in the superseding digital message.

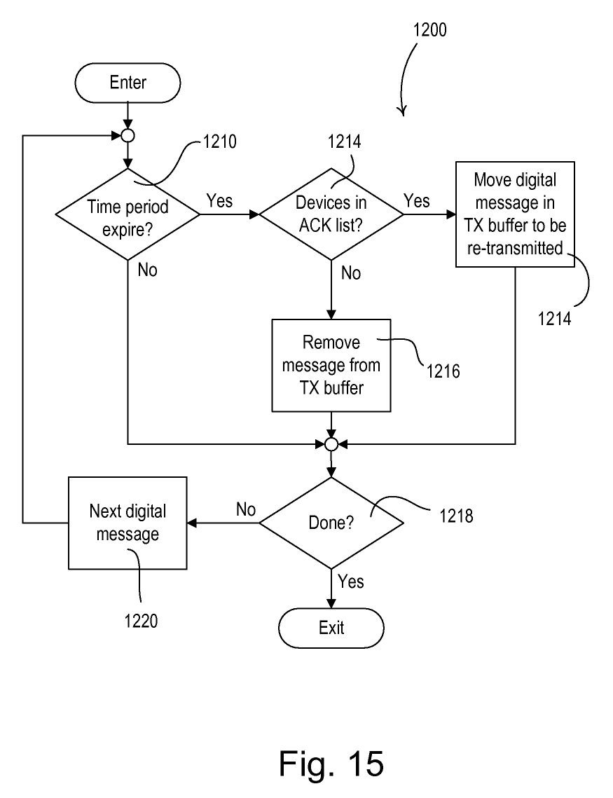

FIG. 15 is a simplified flowchart of an ACK list procedure 1200, which is executed periodically by each of the control devices of the mesh network. During the ACK list procedure 1200, the control device reviews the ACK list for each digital message that was transmitted to ensure that all of the intended recipients received the digital message. If the predetermined time period for a specific digital message has expired at step 1210, a determination is made at step 1212 as to whether there are any control devices in the ACK list. If so, the control device moves the digital message in the TX buffer at step 1214, such that the digital message will be re-transmitted. If there are not any control devices in the ACK list at step 1212, the control devices removes the digital message from the TX buffer at step 1216. Therefore, the ACK list for the digital message will no longer be reviewed during the ACK list procedure 1200.

If the ACK list procedure 1200 has finished at step 1218 (i.e., the control device has reviewed the ACK list for each transmitted digital message), the ACK list procedure 1200 simply exits. However, if there are still ACK lists to review at step 1218, the control devices moves to the next digital message at step 1220 and the procedure 1200 loops around to review the next ACK list.

Therefore, the control devices of the mesh network according to the second embodiment of the present invention are also operable to interrupt the propagation of a first digital message to transmit a second superseding digital message. For example, when a raise button of a keypad of the mesh network is first pressed, the keypad transmits a raise command message as a multicast message at step 1122 during the transmitting procedure 1100. Any control devices that receive the raise command message will store and re-transmit the raise command message. When the raise button of the keypad is released, the keypad will transmit a stop command message as a superseding message (including the sequence number of the previously-transmitted raise command message) at step 1126 during the transmitting procedure 1100. If the stop command message is received by any control device that has received the raise command message, the control device will discard the raise command message to alternatively re-transmit the stop command message.

An RF mesh network is described in greater detail in U.S. Pat. No. 6,879,806, issued Apr. 12, 2005, entitled SYSTEM AND A METHOD FOR BUILDING ROUTING TABLES FOR ROUTING SIGNALS IN AN AUTOMATION SYSTEM, and U.S. Pat. No. 6,980,080, issued Dec. 27, 2005, entitled RF HOME AUTOMATION SYSTEM WITH REPLICABLE CONTROLLERS. The entire disclosures of both patents are hereby incorporated by reference.

Although the present invention has been described in relation to particular embodiments thereof, many other variations and modifications and other uses will be apparent to those skilled in the art. It is preferred, therefore, that the present invention be limited not by the specific disclosure herein, but only by the appended claims.

What is claimed is:

1. A method of transmitting a digital message across a communication network having a plurality of control devices, the method comprising the steps of:
transmitting a first digital message;
propagating the first digital message through the communication network;
determining that a second digital message has a higher priority than the first digital message; and
interrupting the step of propagating the first digital message to transmit the second digital message.

2. The method of claim 1, wherein the step of determining that a second digital message has a higher priority than the first digital message comprises determining that the first digital message is irrelevant in view of the second digital message.

3. The method of claim 2, further comprising the step of:
pressing a button;
wherein the step of transmitting the first digital message is executed in response to the step of pressing a button.

4. The method of claim 3, further comprising the step of:
releasing the button;
wherein the step of determining that the first digital message is irrelevant in view of the second digital message is executed in response to the step of releasing the button.

5. The method of claim 4, wherein the first digital message includes a command to begin adjusting the intensity of a lighting load, and the second digital message includes a command to stop adjusting the intensity of the lighting load.

6. The method of claim 5, wherein second digital message includes the amount of time between the steps of pressing the button and releasing the button.

7. The method of claim 3, further comprising the steps of:
pressing the button once again quickly after the step of pressing a button;
determining that the button has been double-tapped;
wherein the step of determining that the first digital message is irrelevant in view of the second digital message is executed in response to the step of determining that the button has been double-tapped.

8. The method of claim 1, further comprising the step of:
receiving the second digital message prior to the step of determining that the second digital message has a higher priority than the first digital message.

9. The method of claim 8, wherein the step of determining that a second digital message has a higher priority than the first digital message comprises determining that the second digital message was transmitted before the first digital message.

10. The method of claim 8, wherein the step of determining that a second digital message has a higher priority than the first digital message comprises determining that the second digital message is a command message and the first digital message is a system status message.

11. The method of claim 8, wherein the step of determining that a second digital message has a higher priority than the first digital message comprises determining that the second digital message is an acknowledgment propagation message and the first digital message is one of a command message and a system status message.

12. The method of claim 1, further comprising the steps of:
receiving the first digital message; and
transmitting an acknowledgement message in response to first digital message before the step of propagating the first digital message is complete.

13. The method of claim 1, wherein the step of transmitting the first digital message comprises transmitting the first digital message to the plurality of control devices.

14. The method of claim 1, wherein the second digital message includes information regarding the first digital message.

15. The method of claim 1, wherein a first control device executes the steps of transmitting, determining, and interrupting.

16. The method of claim 1, wherein a first control device executes the step of transmitting, and a second control device executes the steps of determining and interrupting.

17. A method of transmitting a digital message across a communication network having a plurality of control devices, the method comprising the steps of:
transmitting a first digital message during a first time slot;
propagating the first digital message through the communication network;
receiving the first digital message; and
transmitting an acknowledgement message in response to first digital message during a second time slot before the step of propagating the first digital message is complete.

18. A radio-frequency load control system for controlling the amount of power delivered from an AC power source to a plurality of electrical loads, the load control system comprising a plurality of control devices adapted to be coupled to an RF communication link for communicating digital messages with each other, at least one of the control devices operable to transmit a first digital message via the RF communication link, such that the first digital message is propagated through the RF load control system, at least one of the control devices operable to receive the first digital message and to control the amount of power delivered to the electrical load in response to the first digital message;
wherein the improvement comprises at least one of the control devices operable to determine that a second digital message has a higher priority than the first digital message, and to interrupt the propagation of the first digital message by transmitting the second digital message.

19. The load control system of claim 18, wherein the control devices further comprise a signal repeater operable to re-transmit the digital messages communicated across the RF communication link, the signal repeater operable to receive the second digital message, to determine that the second digital message has a higher priority than the first digital message, and to re-transmit the second digital message rather than the first digital message.

20. A radio-frequency load control system for controlling the amount of power delivered from an AC power source to a plurality of electrical loads, the load control system comprising:
a plurality of control devices adapted to be coupled to an RF communication link for communicating digital messages with each other;
the plurality of control devices comprising an originating control device operable to transmit a first digital message via the RF communication link, such that the first digital message is propagated through the RF load control system;
the plurality of control devices further comprising a load control device adapted to be coupled between the AC power source and at least one of the electrical loads, the load control device operable to receive the first digital message and to control the amount of power delivered to the electrical load in response to the first digital message;
wherein the improvement comprises the originating control device operable to determine that the first digital message is irrelevant in view of a second digital message, and to interrupt the propagation of the first digital message by transmitting the second digital message.

21. The load control system of claim 20, wherein the originating control device comprises a keypad having one of a button, the keypad operable to transmit the first digital message in response to a press of the button, and to transmit the second digital message in response to a release of the button.

22. The load control system of claim 21, wherein the button comprises one of a raise button and a lower button.

23. The load control system of claim 22, wherein second digital message includes the amount of time between the press of the button and the release of the button.

24. The load control system of claim 20, wherein the originating control device comprises a keypad having one of a button, the keypad operable to transmit the first digital message in response to a first actuation of the button, and to transmit the second digital message in response to a subsequent actuation of the button shortly after the first actuation.

25. A radio-frequency load control system for controlling the amount of power delivered from an AC power source to a plurality of electrical loads, the load control system comprising a plurality of control devices adapted to be coupled to an RF communication link for communicating digital messages with each other, at least one of the control devices operable to transmit a first digital message via the RF communication link during a first time slot, such that the first digital message is propagated through the RF load control system;
wherein the improvement comprises at least one of the control devices operable to receive the first digital message, and to transmit an acknowledgement message in response to first digital message during a second time slot before the propagation of the first digital message is complete.
